(19) United States
(12) Patent Application Publication
(10) Pub. No.: US 2007/0033909 A1
(43) Pub. Date: Feb. 15, 2007

(54) Material and method for fabricating a custom made and fitting an animal boot and shoe

(76) Inventor: Stewart J. Lustgarten, Palm Beach Gardens, FL (US)

Correspondence Address: EDWARDS & ANGELL, LLP, P.O. BOX 55874, BOSTON, MA, 02205, US

(21) Appl. No.: 11/504,750

(22) Filed: Aug. 14, 2006

Related U.S. Application Data
(60) Provisional application No. 60/708,052, filed on Aug. 15, 2005.

(51) Int. Cl. B68C 5/00

(52) U.S. Cl. 54/82

(57) ABSTRACT

A boot for use in shodding a hoofed animal is described. The boot is made up of a base plate that substantially covers the bottom of the hoof, and a wall extending upward from the base plate. When the boot is softened, it can be wrapped around the hoof. When cooled to ambient temperature, it secures the boot to the hoof. The boot is made from a plastic material that has a softening point of less than about 100° C. A shoe, for example, a conventional horse shoe, can be affixed to the bottom plate.

### CROSS-REFERENCE TO RELATED APPLICATIONS

This application claims priority from U.S. Provisional Application Ser. No. 60/708,052 filed Aug. 15, 2005, the disclosure of which is hereby incorporated by reference.

### BACKGROUND OF THE INVENTION

1. Field of the Invention

This invention relates to a shroud covered plastic shoe system for use with hoofed animals, e.g., equine, bovine and swine, and method for fabrication thereof.

2. Description of Related Art

Including Information Disclosed Under 37 C.F.R. §§ 1.97-1.98

Current materials and methods of shoding employ attaching metal and plastic shoes by nail and cement onto the hoof. For example, a horseshoe is usually attached by nailing to the underside of the hoof to protect it from damage. Conventional horseshoes for horses with healthy feet are made from metal, such as cast iron, steel, or an aluminum alloy. One common design of horseshoe is generally arcuate in shape and sized so as to conform to the size of the hoof to be shod. The size and weight of the horseshoe is normally determined by the type of horse being shod. For example, a working horse will be fitted with heavier shoes than a racehorse. In some designs there may be an upstanding tab at the front of the shoe, or a pair of upstanding tabs positioned one to each side of the front of the shoe, designed to assist in locating the shoe on the hoof and to provide additional protection for the toe of the horse's foot. Other designs of metal horseshoe are known, for example, so-called egg, straight and heart-bar shoes.

The traditional way of making horseshoes is for the farrier to forge them from bars of iron which are heated on an open hearth forge, hammered to shape on an anvil, and pierced to provide holes for the horseshoe nails. A farrier can produce shoes in advance for fitting to a horse with healthy feet which he has shod previously and whose hoof measurements he already knows. Alternatively, he can purchase factory made shoes which can in suitable cases be fitted as received to a horse with healthy feet or which may require to be modified somewhat in shape, or in the position or direction of the holes for the horseshoe nails, using a forge and anvil. Often, the horse will be brought to the farrier's smithy to be shoed but many horses are shod at their owner's premises, in which case the farrier will normally bring a portable forge with him in case of need.

Plastics and rubber horseshoes are also known in the art, particularly for shoeing horses suffering from hoof problems. For example, rubber shoes made from a shock-absorbing rubber bonded to a steel or aluminum core are available on the market, as are also horseshoes made from polyurethane and from plastics molded on to an aluminum core. Some of these mimic the form of the conventional metal shoes and, likewise, are attached to the hoof by nails. Another type of currently available horseshoe is sold in kit form, using polyurethane base plates that have to be cut to the shape of the horse's hoof. Plastics tags are then welded at intervals to the outer rim of the base in an upwardly and radially inward fashion. The shoes are then attached to the hoof by cementing the plastic tags to the outer wall of the hoof. Plastics horseshoes have a number of advantages over metal shoes; for example, they are lighter and can be affixed to a horse's hoof by gluing instead of nailing. Thus, they are beneficial for use when a horse is suffering foot problems because they obviate the use of nails. Such foot problems may include laminitis, white line disease (or fungal onychomycosis), navicular disease, sand cracks, or weak heels. Laminitis is a painful condition in which the hoof becomes partly detached from the rest of the hoof capsule along the white line. This can be accompanied by splitting of the hoof. Driving a nail into a hoof in such a condition can exacerbate the problem besides being painful for the horse.

In order to treat an injury to or a disease of a horse's foot, it is usual to cut or abrade away the affected material. Because the pathogens which attack the hoof are generally anaerobic, this helps to speed up a cure. However, there is then the problem of providing support to the trimmed hoof so that the horse can still put weight on its foot without undue discomfort and without exacerbating any misalignment of the horse's leg or, in particular, of the digital bone of the foot, due to the lameness condition from which the horse is suffering. This support can be provided by use of a therapeutic shoe and by using a hoof replacement material to replace the parts that have been cut or abraded away. If the farrier elects to fit a metal shoe then he may have to undertake considerable work to forge a horseshoe of the appropriate shape. If he decides to opt for a plastics or rubber shoe then he may have to cut the shoe to shape or use chemicals with undesirable side effects in order to provide a replacement for the hoof material and any tissue that has been cut or abraded away. If the farrier decides that the horse's foot needs realignment he may decide to provide the horseshoe with a lateral, medial, anterior or posterior extension. This is difficult to effect with a preformed horseshoe.

Most, if not all, plastics horseshoes currently on the market suffer from the disadvantage that they are time-consuming and cumbersome to apply, particularly, those that have to be assembled from a kit of parts. This is at least in part due to the necessity to make the horseshoe fit a damaged foot from which a considerable amount of hoof may have been cut away. Because the horse is lame, it will usually be inconvenient or impractical for it to be brought to the smithy so that the farrier has to take his equipment to the horse's own stable. This tends to make it more inconvenient for the farrier to have to reshape a horseshoe away from his own smithy.

U.S. Pat. No. 6,732,807 B2 discloses a shoe for a hoofed animal, e.g. a horseshoe, which comprises a body made from a thermoplastic composition which comprises a matrix of a thermoplastic material which has a softening point of less than 100.degree. C., such as a polycaprolactone. The method of shoeing a hoofed animal comprises: (a) providing a shoe for a hoof of the animal, the shoe comprising a body which is made from a thermoplastic composition which comprises a matrix of a thermoplastic material having a softening point of less than 100° C. and which has a lower ground-contacting surface for contact, in use, with the ground and an upper foot-contacting surface spaced from the lower ground-contacting surface for contacting, in use, the underside of a foot of a hoofed animal, the body having around at least a part of its upper foot-contacting surface an upstanding peripheral flange portion, and the shoe being adapted to be fitted, in use, on an underside of the hoof with the flange portion extending upwards from a ground border of the hoof adjacent a lower portion of an outer horny wall of the hoof; (b) forming a plurality of indentations in the lower portion of the outer horny wall of the hoof; (c) heating the shoe to a temperature sufficient to soften the thermoplastic material but below its melting point; (d) placing the heated shoe against the underside of the hoof with its flange portion adjacent the lower portion of the outer horny wall of the hoof; and (e) pressing the flange portion of the heated shoe into contact with the outer horny wall of the hoof so as to cause material of the flange portion to enter each of the plurality of indentations, whereby following cooling of the shoe the shoe is retained on the hoof. Also, disclosed is cementing the shoe to the hoof using a suitable bonding cement.

Forming a plurality of indentations in the lower portion of the outer horny wall of the hoof can further weaken a diseased hoof.

Thus, a need still exists in the art for an improved form of horseshoe which can be used in therapy for treatment of such diseases as laminitis and which is simple to apply to the foot of a horse being treated. There is a further need for a novel design of horseshoe which can be readily adapted to fit and provide support for a foot of a hoofed animal from which a variable amount of hoof material, and possibly also other tissue, may have been cut or abraded away. There is still further a need for a horseshoe which can be readily formed to an appropriate shape for treatment of a horse that is suffering from foot problems, particularly when such shaping has to be accomplished in the horse's own stable or stable yard rather than at a farrier's smithy. Additionally there is a need for a horseshoe which can be fitted to the hoof of a horse suffering from laminitis or other condition causing lameness without the use of nails and in a manner which substantially avoids trauma for the horse. Yet, again there is a need for an improved method of shoeing a horse that obviates the need to make holes in the hoof of the horse. There is also a need for a method of shoeing a horse suffering from a debilitating condition, such as laminitis, which avoids trauma for the horse. Moreover, there is a need to provide a novel method of shoeing a horse which avoids the use of a forge.

### SUMMARY OF THE INVENTION

The present invention provides a protective covering boot for a hoofed animal, which substantially envelops the hoof, and which can be custom fit. To this boot wear, a resistant and impervious plastic shoe, or a metal shoe, can be applied. This shoe and boot may prevent infection, cracking and an irritating pebble or stone from lodging into the sensitive dermis tissue of the hoof, itself.

In accord with the present invention, a boot is provided that comprises a base plate that substantially covers the bottom of the hoof, and a wall extending upward from the base plate, which, when softened, can be wrapped around the hoof and which, at ambient temperature, secure the boot to the hoof, the boot being formed from a plastic material that has a softening point of less than about 100° C. Preferably, the wall extends circumferentially from the heel of the animal foot on one side to the heel of the foot on the other side. Thus, the back of the boot may be left open. Also, preferably, a v-shaped cut is made in the front portion of the wall to facilitate wrapping of the wall sides around the hoof, the sides overlapping in the wrapped state and, when folded over, also provides a more protective double-thickness of the wall material at the toe of the hoof. Additional v-shaped notches, if desired, can be easily cut or sheared in by the farrier along the lateral side walls.

In certain preferred embodiments, the bottom plate has a triangular shaped opening at the rear of the boot to coincide with the frog region of a horse's foot. This can permit ambient air to reach tissue to facilitate healing of an anaerobic hoof disease and promote normal tissue respiration. If the boot is preformed with such an opening, if needed for total closure of the hoof underside, a solid or perforated closure insert can be provided and placed in the opening.

The present invention also provides a method for shoding a hoofed animal, the method comprising: providing a boot that comprises a base plate that substantially covers the bottom of the hoof, and a wall extending upward from the base plate, which, when softened, can be wrapped around the hoof and which, at ambient temperature, secure the boot to the hoof, the boot being formed from a plastic material that has a softening point of less than 100° C.; softening the boot by heating; applying the boot to the animal's hoof wherein the base plate of the boot is adjacent to the bottom of the hoof; wrapping the wall of the boot around the hoof; and cooling the boot on the hoof. In certain preferred embodiments of the invention, the method of shoding further comprises affixing a shoe to the base plate of the boot. In other preferred embodiments, an adjustment is made to the hoof by cementing a device directly onto the hoof before applying the boot, in order to provide shock absorbing properties, or as a shim to adjust angulation for how the hoof meets the ground. In still other preferred embodiments, medication can be applied to the hoof using the boot as a reservoir for the medication.

Other features and advantages of the various embodiments of the invention will become apparent upon consideration of the drawings and detailed description that follows.

### BRIEF DESCRIPTION OF THE DRAWINGS

FIG. 1 is an exploded view illustrating a horse's hoof, a boot in accord with the present invention and a shoe.

FIG. 2 is an isometric view illustrating one embodiment of a boot in accord with the present invention.

FIG. 3 is an isometric view illustrating one embodiment of a shoe for attachment to a boot of the present invention.

FIG. 4 is a side view illustrating a boot of FIG. 2 wrapped around a horse's hoof with the shoe of FIG. 3 affixed to the boot.

### DETAILED DESCRIPTION OF THE INVENTION INCLUDING PREFERRED EMBODIMENTS

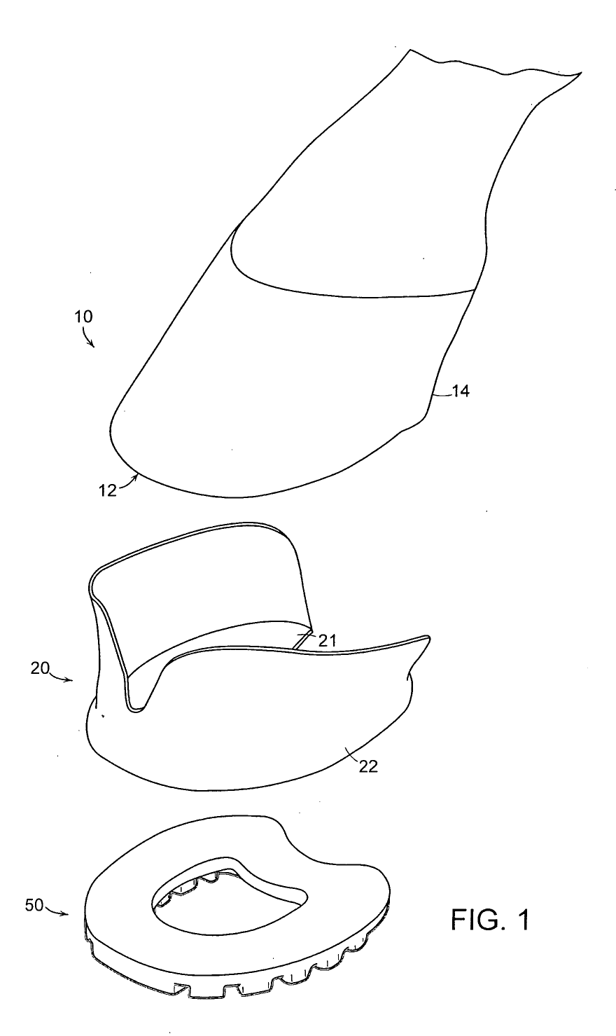

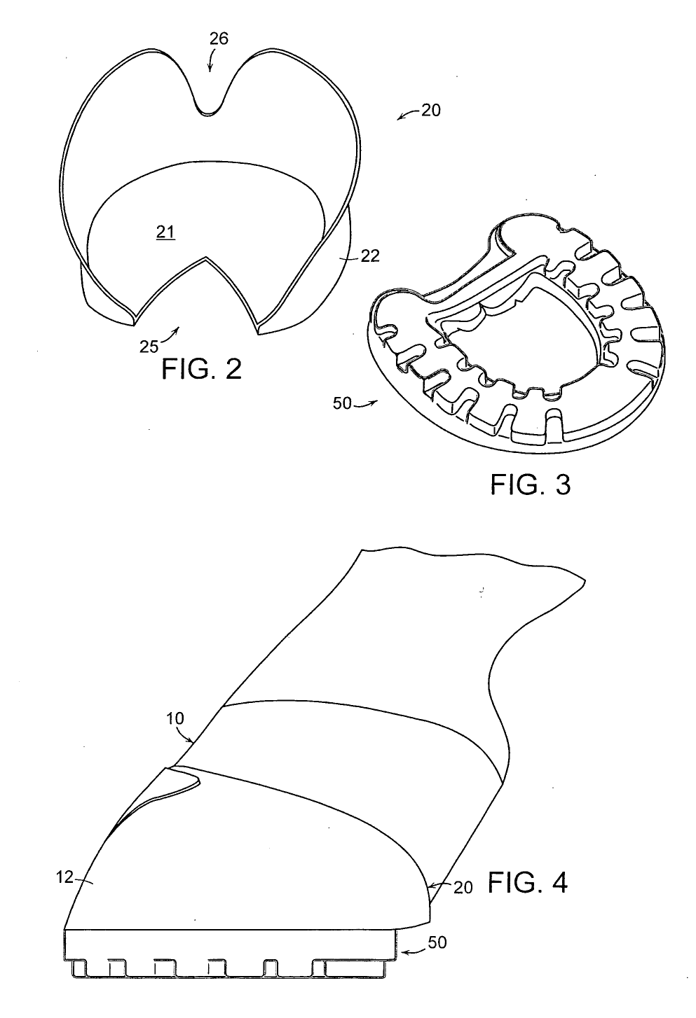

In one embodiment, as illustrated in the drawings, the present invention provides a boot for use in shoding a hoofed animal such as a horse. FIG. 1 illustrates a boot 20 which can be wrapped around a horse's hoof 10, to which a shoe 50 can be affixed. As shown, the boot 20 has a base plate 21 with a substantially circumferential wall 22 extending upward therefrom. In the embodiment shown, a v-shaped or triangular opening 25 is provided in the base plate 21. This opening 25 coincides substantially with the frog region of the horse's foot. Preferably, a v-shaped wall opening 26 also is provided to facilitate wrapping of the boot around the hoof by eliminating material that would require folding of the wall.

The hoof 10 on the foot of a horse comprises a curved covering of horn which protects the front of, and partially encloses, the end of the corresponding digit of the horse. It corresponds generally to a nail on a finger or toe of person. The forward end of the hoof is known as the toe 12, from which the side walls of the hoof extend rearward to a heel 14, the side walls ending on either side of the horse's foot. The hoof surrounds a body of tissue which surrounds the digit itself so as to form a capsule, the underside of which forms the sole. Between the hoof and this body of tissue there is an intermediate layer of tissue called the white line. At the rearward end of the horse's foot there is an elastic horny pad of generally triangular shape which is known as the frog.

Any polymeric material that is hard at ambient temperature and softens below about 100° C. can be used to make the boot 20. A preferred material for this system is polycaprolactone. Polycaprolactone is a low melting temperature thermoplastic material with wear and scuff resistant polyethylene-like properties and which has been shown to be bio-degradable. At temperatures as low as about 140-155° F., polycaprolactone becomes a soft moldable putty-like composition which can be hand formed, fitted and shaped around the hoof from the toe 12 over and around the ground bearing surface to the heel 14 of the hoof. A solid sheeting of polycaprolactone, preferably in thickness of about 1/16″ to ⅝″, can be cut to fit or pre-die-cut or molded into different sizes to a preferred shape and form to fit a particular hoofed animal. Also, a pre-form of the desired size and shape can be molded directly from a polymer resin.

To shod a horse, the hoof is prepared in a conventional manner. Then, the lateral walls of the boot material is softened animal-side with hot water, heat gun, infrared lighting or any other known means that can be used to soften the polycaprolactone or other polymer material. This softened boot material is then applied to and wrapped around the hoof (see FIG. 4). After the boot is fitted to the hoof walls, the boot is cooled by placing the foot in cool water, applying an aerosol spray, or the like. A repeat of this procedure may then be performed to adapt the ground bearing surface of the hoof to the base plate of the corresponding surface of the boot. A suitable bonding resin and/or hoof cement can be applied to the hoof or inside of the boot, if desired for additional bonding in certain cases.

In hoof dermis areas of the ground-bearing surface which may require air transfer, a portion of the covering material can be removed in the frog area as illustrated in the drawings. If a boot pre-from is provided with the opening as illustrated, the frog area can be covered completely, for example, to provide medication. Alternatively, the frog area can be covered with a perforated insert or a mesh insert to provide air transfer to the tissue while protecting the tissue from further injury due to pebbles or stones, or the like. Preferably, the insert is made of the same material as the boot and can be softened and positioned on the hoof, and bonds to the boot when cooled. Thus, the porous mesh-like covering can be applied over this area and it will weld to the boot covering the other epidermis or dermis tissue while still preventing stone and harmful pebble lodgment into these tissues.

This procedure provides a custom fitted and impervious hoof boot that also can serve as a reservoir for containing various hoof medicaments or biocides and/or the boot material itself can be compounded with medicaments or biocides in the material, which will constantly diffuse from the material to treat the diseased hoof.

After the boot is fitted and cooled on the hoof, a shoe can be added, if desired. Any type of shoe, plastic or metal, can be bonded to the boot. Projections can be provided, e.g., on the shoe to embed into the softened boot, for a firmer grip. In preferred embodiments, a plastic polycaprolactone molded shoe 50 of suitable size and shape is bonded to the boot by softening the affixing surfaces.

In another embodiment of the invention, the shoe or another shock resistant material such as, for example, a rubber pad, can be bonded directly onto the ground-bearing surface of the hoof and, then, covered with the boot so that the shoe or other material is within the boot. This combination may afford much needed shock absorbing properties for the hoof upon impact with the ground from the plasticity of the material within itself or from the rubber (natural or synthetic) device bonded to the hoof.

Applicant has discovered that, by attaching a softened polycaprolactone shoe on the bottom of the softened surface of a polycaprolactone boot, the hoof can be placed on a cold surface and the full weight of the animal placed upon the hoof to establish the correct angulation of the hoof and shoe to the ground.

Angulation of the hoof with the ground also can be provided by appropriate lengths of extruded forms of square, round or thick walled tubing which can be softened and bent to form a curved shoe and placed directly into the softened material to form a weld with the ground bearing surface of the boot or cemented directly to the hoof and, then, wrapped with the boot. Angulation adjustment of how the hoof meets the ground also can be provided by utilizing shims out of suitable material inside the boot. Preferably, a polycaprolactone material is used, which when softened, will bond to the total system.

Conveniently, the boot with shoe attached, is re-usable if the shoe or boot is not worn when the hoof requires additional trimming. The boot with shoe attached can be easily cut off with a cast saw, or hot knife, or other suitable apparatus and re-applied and re-fitted directly to the hoof using hot water, infrared light, a heat gun, or the like to soften the material. If the shoe portion of the boot is severely worn and require replacement, this also can be easily performed and a new shoe welded to a used boot upon heating the matching surfaces of both.

The boot material can be supplied in various colors so that, for example, the material of the boot will allow color-coding identification of a horse when out in a field or elsewhere, or for coordinating the horse with rider custom for events.

Further, polycaprolactone can serve to fill in missing hoof aspects and cracks. It also has been found that metallic foil such as aluminum foil readily laminates to the polycaprolactone and can be used to simulate the original surface of the hoof, so repaired.

The plastic boot and shoes combination in accord with the present invention ushers in an entirely new era for the comfort and protection of horses hooves. Requiring no adverse nails or cements, the pre-formed boot can be provided in various sizes, can be easily formed and can be fitted to envelope the entire epidermal hoof surface. The boot can be relatively long lasting and can provide the same impervious protection as high density polyethylene. The preferred polycaprolactone also is biodegradable. The boot can be fitted to the hoof in a matter of minutes and is easily removed between hoof trimmings and then easily re-applied. The boot also serves as a reservoir for various hoof treatments and medicaments and the user also has the choice of leaving open, or covering, the sensitive dermal frog area.

Once the boot is applied directly to the hoof, in preferred embodiments, the proper size shoe surface is easily softened with hot water or steam and fuses to the bottom of the softened boot undersurface. The softening of both surfaces (i.e., boot and shoe) forms a secure weld and allows the animal to place its entire weight immediately on the boot and shoe to establish normal hoof to ground angulation. However, shims also can be used to provide normal hoof to ground angulation. Once proper angulation is established, the boot and shoe are quickly cooled with cold water, or the like, and the horse now can go about its normal routine.

If desired, all hoof side and underside boot margins can also be sealed further with a glue gun, suitable sealant, or the like.

For those who desire direct cementation of the shoe to the hoof itself, any conventional a bonding and cement system can be used. However, the wrapping of the softened boot material around the hoof before cooling provides a good fit for the boot. A preferred cement is disclosed in a copending application entitled “METHODS AND COMPOSITIONS FOR CEMENTING SHOES ON HOOFED ANIMALS AND FOR HOOF REPAIR,” Ser. No. 11/495,194, filed Jul. 28, 2006 (claiming priority from U.S. Provisional Application Ser. No. 60/702,850 filed Jul. 28, 2005), the disclosure of which is hereby incorporated by reference.

The invention has been described in detail including the preferred embodiments thereof. However, it will be appreciated that those skilled in the art, upon consideration of this application including the drawings, may make modifications and improvements within the spirit and scope of the present inventions. For example, any known shape and any material for a horseshoe can be used with the boot of the present invention. Also, the shoes can be affixed by mechanical dove tailing of the softened boot material flowing through the shoe retention holes, slots or groves, as well as providing projections on the shoe to penetrate the softened boot material and then the material is cooled and hardened.

1. A boot for use in shodding a hoofed animal, the boot comprising a base plate that substantially covers the bottom of the hoof, and a wall extending upward from the base plate, which, when softened, can be wrapped around the hoof and which, at ambient temperature, secures the boot to the hoof, the boot comprising a plastic material that has a softening point of less than about 100° C.

2. The boot of claim 1, wherein the wall extends circumferentially from the heel of the animal foot on one side to the heel of the foot on the other side.

3. The boot of claim 1, further comprising a v-shaped cut in a portion of the wall.

4. The boot of claim 1, further comprising a v-shaped cut in a front portion of the wall.

5. The boot of claim 1, wherein the bottom plate has a triangular shaped opening at the rear of the boot

6. The boot of claim 1, further comprising a medicament.

7. The boot of claim 1, further comprising a shoe affixed to the bottom plate.

8. The boot of claim 7, wherein the shoe comprises a plastic material.

9. The boot of claim 7, wherein the shoe comprises a metal.

10. The boot of claim 1, wherein the wall is made from a material comprising polycaprolactone.

11. The boot of claim 1, wherein the boot is made from a material comprising polycaprolactone.

12. A method for shodding a hoofed animal, the method comprising:
providing a boot comprising a base plate that substantially covers the bottom of the hoof, and a wall extending upward from the base plate, which, when softened, can be wrapped around the hoof and which, at ambient temperature, secures the boot to the hoof, the boot comprising a plastic material that has a softening point of less than about 100° C.;
softening the boot by heating; applying the boot to the animal's hoof wherein the base plate of the boot is adjacent to the bottom of the hoof;
wrapping the wall of the boot around the hoof; and
cooling the boot on the hoof.

13. The method of claim 12, further comprising affixing a shoe to the base plate of the boot.

14. The method of claim 12, further comprising cementing a device directly onto the hoof before applying the boot.

15. The method of claim 14, wherein the device provides shock absorbing properties.

16. The method of claim 12, further comprising adjusting angulation for how the hoof meets the ground.

17. The method of claim 12, further comprising applying medication to the hoof.

18. The method of claim 12, further comprising affixing a shoe to the bottom plate.

19. The method of claim 12, further comprising softening the boot material using hot water, hot air, or infrared radiation.

20. The method of claim 12, further comprising sealing exposed edges of the boot to the hoof.

21. The method of claim 12, wherein the boot is made from a material comprising polycaprolactone.
